(19) United States
(12) Patent Application Publication
(10) Pub. No.: US 2022/0369582 A1
(43) Pub. Date: Nov. 24, 2022

(54) HYDROPONIC SMART SYSTEM AND ASSOCIATED METHODS

(71) Applicant: Focus Universal Inc., Ontario, CA (US)

(72) Inventor: Desheng Wang, Diamond Bar, CA (US)

(21) Appl. No.: 17/747,888

(22) Filed: May 18, 2022

Related U.S. Application Data
(60) Provisional application No. 63/190,563, filed on May 19, 2021.

(51) Int. Cl. A01G 31/02; A01G 7/04; G05B 19/416

(52) U.S. Cl. CPC A01G 31/02; A01G 7/045; G05B 19/4166; G05B 2219/45006

(57) ABSTRACT

Disclosed is a system and method for a smart hydroponic system. The system includes a central controller and one or more smart hydroponic system modules. The smart hydroponic system modules automate a number of tasks required to maintain hydroponic agriculture. Further, these tasks are localized to provide greater precision to the agriculture, as even indoor environments can vary. The central controller sends commands which affect every smart hydroponic system module. This provides an efficient mix of central and local control.

### CROSS-REFERENCE TO RELATED APPLICATIONS

The present application claims the benefit of priority to U.S. Provisional Patent Application No. 63/190,563, filed May 19, 2021, the disclosure of which is hereby incorporated by reference in its entirety. Any and all applications for which a foreign or domestic priority claim is identified in the Application Data Sheet as filed with the present application are hereby incorporated by reference under 37 CFR 1.57.

### FIELD

The present invention relates to a system and method of hydroponic agriculture.

### BACKGROUND

Indoor agriculture, and particularly hydroponic agriculture, often requires that plants are grown in sand, gravel, or liquid. In part, this is simply because there is no native soil indoors, unless the building lacks a floor structure such as a slab. Structures lacking floors are uncommon in the 21st century. Because sand, gravel, or liquid lack some of the essential nutrients commonly found in soil, nutrients may be added to the sand, gravel, or liquid to enable the plants to grow. While this method of agriculture is generally referred to as hydroponics, but can take a number of different forms, including deep water culture, and nutrient film technique, as just two examples.

Because growers are not relying on the inherent nutrient composition of the soil, the nutrient mix may be adjusted. The fact that only some, or no, nutrients required by plants for ideal growth are present. This represents a problem for the growth of the plants, but also provides an opportunity. The opportunity is that nutrients can be added. Not only can they be added, but a grower is not handcuffed as the grower would be if the grower were working outdoors in the soil. When working outdoors in the soil, a grower is handed the doubled edged sword of having nutrients present, and thus not having to bear the cost of added them, but must accept the nutrient mix present. In hydroponics, the nutrient mix may be optimized or otherwise beneficially combined, because all the nutrients are being added by the grower. The beneficial combination of the nutrient mix means that growth may also be improved.

Further, because of the hydroponics taking place indoors, plants are not subject to the adverse weather conditions which are present from time to time outdoors. For example, the plants may be spared severe heat and storms. The plants are not subject to flooding because the water reaching them is controlled by the grower.

However, even indoor environments may affect the mix of nutrients. The humidity of indoor environments may vary, as well as the temperature. More importantly, indoor environments, and particularly large indoor environments, are not monolithic. That is, the indoor environment may have variation. For example, if there is a metal door in a wall, the metal door may radiate heat to the indoor environment at a greater rate than an insulated wall surrounding the metal door, or an insulated wall across the indoor space from the metal door. Thus, the heat may drastically affect the hydroponics, particularly when the plants are placed in a liquid.

Many growers simply set and forget, that is, they add an beneficial mix of nutrients, but do not monitor more than a single testing site. Naturally, given the possibility for variation of environmental factors, even in an indoor environment, the nutrient mix may not stay at optimum in every part of an operation. Moreover, given the variation possible, even in an indoor environment, one portion of the plants may be optimized, while other portions may not. The portions that are not optimized may go completely unnoticed. This can correspondingly lead to a poorer crop than would be possible were all portions optimized.

For the foregoing reasons, there can be improved systems which can monitor various aspects of the hydroponic farm, and provide control for the systems in operation in the hydroponic farm.

### SUMMARY

Disclosed is a system for hybrid centralized and local control of a hydroponic system. The system may include a central controller which may send commands using a power line control protocol, and may further include a computing unit electrically connected to the central controller, the computing unit may include a processor and a memory, the memory may include instructions executing on the processor to receive measurements, the computing unit may check the measurements against user input parameters, and may send commands if the measurements are outside of the parameters. The system may further include a light fixture, which may be electrically connected to the computing unit, a temperature sensor, which may be electrically connected to both the light fixture and the computing unit, and a tank containing a volume of a liquid.

The system may still further include a tank valve, which may be in electrical communication with the computing unit, the tank valve may include an outlet which may be in fluid communication with the tank, a first tank valve inlet which may be in fluid communication with a liquid source and the outlet, and a second tank valve inlet which may be in fluid communication with the outlet. The system may still further include an additive valve which may be in electrical communication with the computing unit, the additive valve may include an outlet which may be in fluid communication with the second tank valve inlet, a first additive valve inlet which may be in fluid communication with a pH up tank, and a pH down tank, and a second additive valve inlet which may be in fluid communication with a fertilizer tank. Lastly, the system may further include a sensor package which may be at least partially submerged in the volume of liquid in the tank. The sensor package may include at least a first sensor which may measure the pH of the liquid in the tank, a second sensor which may measure the electrical conductivity of the liquid in the tank, and a third sensor which may measure the liquid level in the tank. The central controller may send commands to control at least the at least one fixture, and, based on measurements from the temperature sensor, the sensor package, or both, the computing unit may send commands to the tank valve, the additive valve, and the light fixture.

Further disclosed is a method for operating a smart hydroponic system. The method may include providing a central controller which may be connected to a power line. The method may also include connecting a computing unit to the power line, connecting an air temperature sensor, and connecting at least one sensor submerged in a volume of liquid to the computing unit. The method may further include placing at least one electrically actuated valve in electrical communication with the computing unit, placing a light fixture in electrical communication with the central controller and the computing unit, and may include sending commands from the central controller using a power line communication protocol. The commands may affecting at least the operation of the light fixture. Finally, the method may include sending commands, which may be based on measurements from the air temperature sensor or the at least one sensor, from the computing unit to control the operation of the of the at least one electrically actuated valve and the light fixture.

Further disclosed is a system for optimizing hydroponic growth through a combination of central and local control. The system may include a central controller which may generate commands using user input parameters. The system may further include one or more smart hydroponic system modules which may be electrically connected to the central controller. The one or more smart hydroponic system modules may include a computing unit. The computing unit may include a processor and a memory. The memory may include a set of instructions which may direct the computing unit to receive measurements, and, based on the measurements, may direct the computing unit to process commands for execution on the processor. The system may further include a temperature sensor which may be electrically connected to the computing unit. The temperature sensor may take a first portion of the measurements and may send the first portion of the measurements to the computing unit. The system may further include a sensor package which may be electrically connected to the computing unit. The sensor package may take a second portion of the measurements and may send the second portion of the measurements to the computing unit. The system may further include at least one valve which may be electrically actuatable between establishing fluid communication between a first inlet and an outlet, a second inlet and the outlet and an off position. The electric actuation may be controlled by commands send by the computing unit. Finally, the system may include a light fixture which may be electrically connected to the computing unit and the central controller. The light fixture may be adapted to turn on, turn off, or dim, which may be based on both commands send from the central controller, and commands from the computing unit, the commands from the computing unit may be based on either the first portion of the measurements or the second portion of the measurements.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a schematic view of the smart hydroponic system module; and

FIG. 2 shows a schematic view of the smart hydroponic system.

### DETAILED DESCRIPTION

The detailed description set forth below in connection with the appended drawings is intended as a description of various embodiments of system and method to monitor and control a hydroponic farm, and is not intended to represent the only form in which it can be developed or utilized. The description sets forth the functions for developing and operating the system in connection with the illustrated embodiments. It is to be understood, however, that the same or equivalent functions may be accomplished by different embodiments that are also intended to be encompassed within the scope of the present disclosure. It is further understood that the use of relational terms such as first, second, distal, proximal, and the like are used solely to distinguish one from another entity without necessarily requiring or implying any actual such relationship or order between such entities.

A hydroponic farm is a complex operation. Plants may be placed in a liquid and the liquid may be infused with nutrients to aid growth. Although some hydroponic farms may be outdoors, most are indoors, and therefore require artificial lighting to provide light for photosynthesis. The larger the farm, the more likely the variation in environmental conditions between areas in the farm, even indoors. Thus, lighting solutions are beneficial for plant growth, but the temperature can be monitored so that the lights and other heat sources do not increase the temperature to levels which would damage the plants. In terms of the liquid environment, two parameters of the nutrient solution that may be monitored and controlled may be the hydrogen ion concentration, which is a measure of the acidity or alkalinity of a solution (pH), and electrical conductivity (EC). The disclosed system includes control of lighting and monitoring of temperature. The control and monitoring seek to optimize operation of the lighting through a mix of centralized and decentralized control of various aspects of the lighting's operation. Further, the system provides localized monitoring of pH and EC, and well as localized control of nutrient mix in the liquid to optimize conditions for plant growth.

Further, the system places monitoring and control of every aspect of the system in a single location on the user interface of a computing device. The computing device may be a mobile device such as a smart phone, a tablet, or a laptop, or a stationary device, such as a desktop computer or a programmable logic controller including a touch screen. The user interface may include fields for input of various of parameters to control operation of the system, and to access measurements by various measuring devices, as is described in greater detail below. The computing device may be connected wirelessly to a central controller. The wireless connection may be made through any number of protocols known in the art. For example, the wireless connection may be a wireless communication link, for example, Wi-Fi, Bluetooth®, cellular (3G, 4G, 5G, LTE, etc.), or other suitable wireless communication technology.

The timing of the lighting may be automated by a central controller. That is, the central controller may turn one or more light fixtures in smart hydroponic system modules on and off at times predetermined by a user and input as parameters in the central controller. The parameters may be input either using the computing device or directly using a hardware interface on the controller. In addition to the centralized control, a temperature sensor may be located on every lighting fixture. As used herein, the term “lighting fixture” is meant to include both a lighting element and a ballast combination unless specifically stated otherwise. The temperature sensor may include providing measurements which could trigger a dimming command or shut off command of the light fixture, should the temperature reach predetermined threshold temperatures for each of those operations. Again, these threshold temperature parameters may be input using the computing device user interface or by the hardware interface on the central controller.

Sensors placed locally on the smart hydroponic system modules may monitor pH and EC in the liquid. The computing unit may receive the measurements from the sensors and pass the measurements to the computing unit, and then to the central controller, which may pass the measurements to the computing device, which may collect and display the measurements. The computing unit may further automatically control the addition of nutrients to the liquid to bring the nutrient mix back to an optimum state. Alternatively, before taking action, the computing unit may send a message to the central controller, which may in turn send the message to the computing device. The message may ask a user's permission before adding nutrients. The message may take the form of a pop up on the computing device, the pop up including providing radio buttons which allow a user to select to provide or deny permission for the system to act. Parameters may be set to establish tolerances for the nutrients. This prevents the computing unit from acting too aggressively when placed on automatic control. The mix of centralized and decentralized control and monitoring solves several technical shortcomings with the state-of-the-art systems while creating time savings and optimizing plant growth and yield.

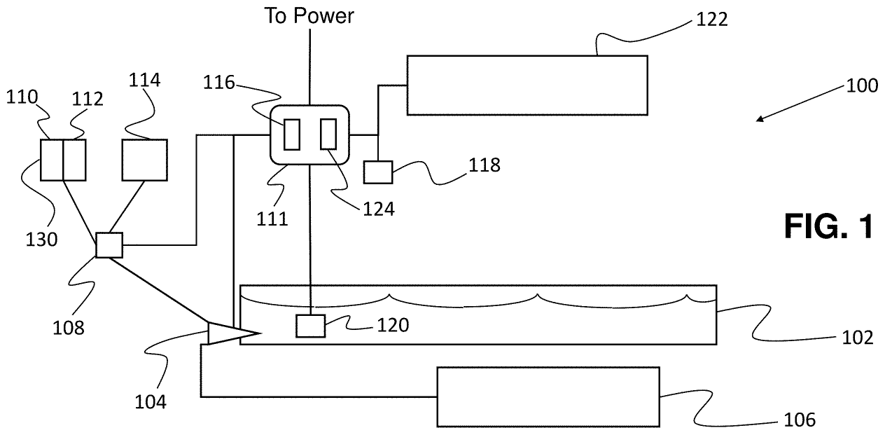

More specifically, as shown in FIG. 1, the smart hydroponic system module 100 may include a tank 102, a tank valve 104 in fluid communication with the tank 102. The tank valve 104 controls water and additive flow in to the tank 102. A liquid source 106 may be connected to a first inlet of the tank valve104, and an additive valve 108 may be connected to a second inlet of the tank valve 104. The additive valve 108 may control which additive flows to the tank valve 104. A pH tank 130 may be connected to a first inlet of the additive valve 108. The pH tank 130 may include a “pH up” additive compartment 110, and a “pH down” additive compartment 112. A fertilizer tank 114 may be connected to a second inlet of the additive valve 108. A computing unit 111 may control both the tank valve 104 and the additive valve 108 through an electrical connection. The computing unit 111 receives data from the light temperature sensor 118, and the tank sensor package 120. The computing unit 111 and light temperature sensor 118 both connect to, and take part in the control process for, a light fixture 122.

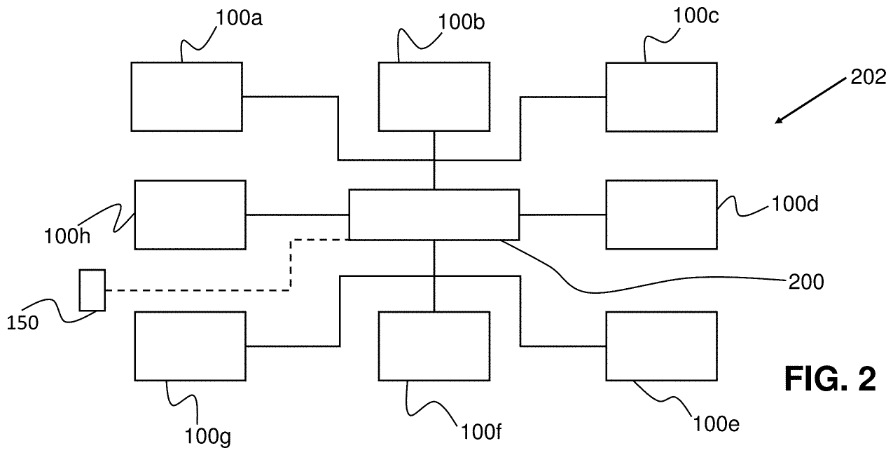

As shown in FIG. 2, a smart hydroponic system 202 may include a central controller 200 and one or more smart hydroponic system modules 100a-h. The computing device 150 may be wirelessly connected to the central controller 200, as indicated by the dashed line. Although eight smart hydroponic system modules are shown, it is understood that there may be fewer than eight or more than eight, as discussed above.

Plants (not shown) may be placed in the tank 102. The tank 102 may be part of a deep water culture (DWC) system or a nutrient film technique (NFT) trough, or other hydroponic farming system. The tank 102 may have varying amounts of liquid in it. The tank 102 may have a bottom and two sets of opposing sides. Each side may be connected along a longitudinal edge of the side to an edge of the bottom, and at first and second ends of the side to an end of an adjacent side. An outlet of the tank valve 104 may be placed on one of the sides, so that the tank valve 104 outlet is fluidly connected with the tank 102. The top of the tank 102 may be open, or it may be partially enclosed. When the top is partially enclosed, the top may include a plurality of openings through which plants may protrude. The top on the tank 102 may help to inhibit the growth of algae and to minimize evaporation, as is discussed in detail below. The tank 102 may also include an air pump (not shown) which may be placed submerged in the liquid, particularly when the tank 102 is part of the DWC system. The pump oxygenates the liquid in the tank 102. Plants absorb oxygen in the liquid through their roots, enabling growth of the plants.

The tank 102 may have containers placed in it for holding the plants in a certain orientation. For example, the plants may be placed in a substantially cylindrical mesh container or a mesh tray. The mesh container or mesh tray may hold a media for orienting the plant in an upright position while allowing access to the roots. The mesh allows the liquid to pass through the container and contact the roots. This allows the roots to absorb nutrients from the liquid.

The top of the tank102 may be as closed as possible to mitigate the exposure of the liquid to light. As the liquid may have high levels of nitrogen, phosphorous, carbon and potassium to create the optimum nutrient mix for the plants, light can provide the energy to feed the growth of algae and create a bloom. Too much algae can harm the plants in the hydroponic system by blocking the equipment, including the air pump and the tank valve 104, and by depriving the roots of the plants of oxygen. Algae will absorb all of the oxygen, leaving none or very little for the plants. The top may help to prevent evaporation from the tank 102 as well, by allowing less exposure to environmental air. This is a benefit because, especially if the environment is dry, water can evaporate quickly, raising costs for the hydroponic farm.

The tank valve 104 may include an outlet in fluid communication with the tank 102. The tank valve 104 may further include two inlets. A first inlet is in fluid communication with a liquid source 106. The liquid source 106 may be a supply from a water utility, or a reservoir, or a combination of both. A second inlet is in communication with an additive valve 108. The tank valve 104 is an electrically actuated valve, and is in electrical communication with the computing unit 111. The computing unit 111 may send commands to the to the tank valve 104 which cause the tank valve 104 switch between fluid communication with the first inlet with the outlet, the second inlet with the outlet, and an off position with no fluid communication. Such commands may be overridden or modified by commands from the computing device 150 should the user wish to override or modify any of the commands.

The additive valve 108 may include an outlet in fluid communication with the tank valve 104. The additive valve 108 may further include two inlets. A first inlet is in fluid communication with a pH additive tank 130. The pH additive tank 130 may include a first compartment 110 which holds a liquid, the liquid's composition such that the liquid will raise the pH of the liquid in the tank 102. The pH additive tank 130 further may include a second compartment 112 which holds a liquid, the composition of which lowers the pH of the liquid in the tank 102. A second inlet may be in fluid communication with a fertilizer tank 114. The fertilizer tank 114 may hold a liquid which includes nutrients for the plants in the tank 102. The additive valve 108 may further be in electrical communication with the computing unit 111. The computing unit 111 may send commands to the additive valve 108 which cause the additive valve 108 to move between a fluid communication between the first inlet and the outlet, the second inlet and the outlet, and an off position with no fluid communication. Such commands may be overridden or modified by commands from the computing device 150 should the user wish to override or modify any of the commands.

Various sensors may be electrically connected to the computing unit 111. A temperature sensor 118 may be electrically connected to the computing unit 111 and the light fixture 122. The temperature sensor 118 may measure the temperature of the air near the light fixture and the plants and send the measured temperature as data to the computing unit 111. The computing unit 111 may include a processor 116 which executes instructions stored on a memory 124 to check the data against parameters stored on the memory 124, which is electrically connected to the processor 116. If the temperature is outside of the parameters stored in the instructions, the instructions may cause the processor to send a command to the light fixture to dim or shut down. The details of the operation of the hydroponic smart system 100 are discussed in detail below.

Further, a sensor package 120 may be electrically connected to the computing unit 111. The sensor package 120 may include a plurality of sensors. For example, the sensor package 120 may have a sensor for pH, a sensor for EC, a sensor for liquid level, and a sensor for liquid temperature, or any combination of sensors depending on the application and the location of the hydroponic farm. The sensor package 120 may pass data, including the various measurements taken by the sensors, to the computing unit 111. The computing unit 111 may receive the data and execute instructions stored on the memory 124 using the processor 116 to check the measurements against stored parameters. The stored parameters may have been previously input to the memory 124 either using a hardware interface on the central controller 200 or the computing device 150. The computing unit 111 may send commands to the tank valve 104 or the additive valve 108, or the light fixture 122, or some, or all, of the above in combination based on the check of the measurements against the parameters. Again, the details of the operation of the hydroponic smart system 100 are discussed in further detail below.

The sensor package 120 may be at least partially submersed in the liquid contained by the tank 102. The sensor package 120 may have single housing including all of the sensors, or may include a separate housing for each sensor. Alternatively, one housing may have more than one sensor, and other housings may have a single sensor. Still further alternatively, the liquid level sensor may only be in a separate housing. The liquid level sensor may be located in an interior of the tank 102. The liquid level sensor may be place partially submerged, and partially above, the liquid level in order to properly measure the liquid level in the tank 102.

The hydroponic smart system module 100 may be connected to a power line through a standard outlet in a structure. The computing unit 111 may include a protocol which allows the computing unit 111 to receive commands sent over the power line from a central controller 200. The method of sending commands over the power line is commonly called power line control. As shown in FIGS. 1 and 2, the central controller 200 may be connected to a plurality of smart hydroponic system modules 100a-h. Although eight smart hydroponic system modules 100a-h are shown connected to the central controller 200, it is understood that this is merely exemplary, and that there may be more than eight hydroponic smart system modules 100 connected to the central controller 200 or fewer than eight smart hydroponic system modules 100 connected to the central controller 200. One limitation to the number of hydroponic smart system modules 100, which may be connected to the central controller, may be the total number of electrical sockets in a structure.

Additionally or alternatively, smart hydroponic system modules may be added at any point in the future to the system 202. The system 202 is not limited to the number of smart hydroponic system modules with which the system starts. Additionally, smart hydroponic system modules may be removed from the system. Thus, the system 202 does not have a fixed number of smart hydroponic system modules with which the system 202 can operate. There is no maximum, and there is no minimum number of smart hydroponic system modules. Use of the protocol ensures that future added smart hydroponic system modules will be able to interoperate with the already connected system 202.

The power line control system and other aspects of Power Line Communication (PLC) are disclosed in International Patent Publication WO 2021/107961, which is hereby incorporated by reference herein for all purposes. The central controller 200, either autonomously or as a pass through for the computing device 150, may send commands over the power line to one or more of the smart hydroponic system modules 100a-h. Thus, the smart hydroponic system modules may be controlled by both the computing device 150, the central controller 200, and controlled locally by the computing unit 111 based on input from the sensor package 120 and the temperature sensor 118. It should be noted that commands are divided between central and local control in order to take advantage of each. That is, commands are not divided between central and local control simply according to user preference. Some commands may be reserved to central control, and other commands may be reserved to local control. Alternatively, some commands may be given by both central control and local control, but at different times or because of different inputs to the computing unit 111. Moreover, it should be further noted that not only may smart hydroponic system modules 100 be added to the system 202, but additional sensors, valves, or other components may be added to one or more of the smart hydroponic system modules, and the system would not function differently, as described in detail below.

Alternatively, the central controller 200 may connect to each of the smart hydroponic system modules through a wireless connection. The wireless connection may be made through any number of protocols known in the art. For example, the wireless connection may be a wireless communication link, for example, Wi-Fi, Bluetooth®, cellular (3G, 4G, 5G, LTE, etc.), or other suitable wireless communication technology. Commands from the central controller 200 may be sent using the above protocols while preserving the local control for the computing unit 111. The computing unit 111 may still connect to the lighting fixture 122, the temperature sensor 118, the sensor package 120, the tank valve 104, and the additive valve 108 through wired connections, and commands sent to the above components from the computing unit 111 using a wired protocol, including the power line control protocol. When the central controller 200 and the computing unit 111 are connected wirelessly, both the central controller 200 and the computing unit 111 may have wireless transceivers for the purpose of transmitting and receiving messages and commands.

Still further alternatively, the computing unit 111 may be connected to the lighting fixture, 122, the temperature sensor 118, the sensor package 120, the tank valve 104, and the additive valve 108 through wireless means. The wireless connection may be made through any number of protocols known in the art. For example, the wireless connection may be a wireless communication link, for example, Wi-Fi, Bluetooth®, cellular (3G, 4G, 5G, LTE, etc.), or other suitable wireless communication technology. The computing unit 111 sends commands to the components using the appropriate protocol when connected using that protocol. When connected by wireless means, every component will have a transceiver for purposes of wireless interoperation, including sending and receiving messages and commands.

A single power line input may provide power to every component of the hydroponic smart system 100. Alternatively, the hydroponic smart system 202 may have some components powered by one power line output, and other components powered by a different power line output. One power line output may be input in to the computing unit 111. The computing unit 111 may provide power distribution for the hydroponic smart system module 100. The computing unit 111 may include transformers which bring the power line voltage, which is nominally 120 volts in North America, down to a low voltage range for operating the tank valve 104, the additive valve 108, the temperature sensor 118, and the sensor package 120. This power may be provided to the tank valve 104, the additive valve 108, the temperature sensor 118, and the sensor package 120 through wired connections such as standard low voltage wiring as is well known in the art. The low voltage power may also be self-distributed to the computing unit 111 to power the various components, including the memory 124 and the processor 116, of the computing unit 111. The computing unit 111 may distribute full 110 volt power to the lighting fixture 122. This power may be distributed by providing a bypass prior to any transformation of the power received by the computing unit 111 from the outlet.

In operation, the hydroponic smart system 100 may operate on repeated 24-hour day/night cycles. For ease of explanation, this disclosure will divide a 24-hour cycle by starting at an artificial sunrise, which is created by the powering on of the one or more light fixtures 122, and ending the moment before the artificial sunrise begins again. Because the hydroponic smart systems 100a-h and controller 200 are installed indoors, the rise and setting of the Sun are not relevant. This rise and setting of the Sun are replaced by power on and shut down of the artificial lighting provided by the light fixtures 122. However, the powering on and off of the light fixtures 122 may be keyed to the actual sunrise and sunset at the geographic location, should a user chose to set up the system 202 to operate that way.

In the case of a first power on of the system 202, that is, the computing device 150, central controller 200 and smart hydroponic system modules 100a-h combination, there are a few differences as compared to a subsequent power on. In a first power on, after the computing device 150, or central controller 200, or both, are powered up, woken up from sleep mode, or connected via a wired or wireless connection to the hydroponic smart systems 100a-h, the controller 102 may interrogate the computing units of the smart hydroponic system modules 100a-h connected to the power line, and provide any returned information to the computing device 150. This is done by the central controller 200 sending a command to the smart hydroponic system modules 100a-h to respond to the command with identification information. If the central controller 200 and/or computing device 150 is already connected, the protocol may require that a smart hydroponic system modules 100a-h which is later connected to the system 202 send self-identification information to the central controller 200. It should be noted that the self-identification information may further include identification of individual components of the smart hydroponic system modules 100a-h. These may include the lighting fixture 122, for example. Thus, the central controller 200 may send commands which pass through the computing unit 111 to components such as the lighting fixture 122. However, such pass-through commands are not limited to commands for the lighting fixture 122. The central controller 200 may also send commands for the tank valve, the additive valve, or any other component.

After a first power on, because the central controller 200 is able to identify each smart hydroponic system modules 100a-h, and even components of the smart hydroponic system modules, individually, future commands may be specified as being for a particular smart hydroponic system modules 100a-h or component of a smart hydroponic system module 100. Because these commands contain information identifying the smart hydroponic system modules 100a-h or component thereof to which they are directed, the commands will be ignored by other smart hydroponic system modules 100a-h. Alternatively, some or all of the smart hydroponic system modules 100a-h could be specified by a command. Thus, groups of smart hydroponic system modules 100a-h, for example, a group of smart hydroponic system modules 100a-h in a specified area of a structure, may be controlled as a group. Or, if, for example, all smart hydroponic system modules 100a-h need to be powered up or down, this can also be accomplished through the above identification of all smart hydroponic system modules 100a-h. In fact, there may be a particular identifier in the protocol specifying that a command is for all components connected to the central controller 200. Such an identifier prevents the protocol from requiring that each smart hydroponic system modules 100a-h, have an individual identifier separately listed in the command.

The computing device 150 or the central controller 200 may send a “power on” command for the light fixtures 122. The power on may be further controlled by ramping up the light fixtures 122 during power on. Ramping up may use variable wattage settings of the light fixture 122 to gradually increase from a lower brightness to a greater brightness until the light fixture 122 reaches the maximum wattage. This function is of great benefit in indoor agriculture, because the ramping simulates sunrise, allowing the lighted crops to function as if they were in an outdoor environment. Both the power on time for the hydroponic smart systems 100a-h and, more specifically, the lighting fixtures 122 may be set as parameters in the central controller 200 by a user, either using the native hardware interface or the computing device 150. Whether the power on is to include a ramping of the light wattage may also be set as a parameter in the central controller 200 by the user, also either using the native hardware interface or the computing device 150. Further, the exact time for the ramping overall, as well as the time intervals for the increase, and the starting wattage, and wattage increase at the specified time intervals may all be set as parameters in the central controller 200, again either using the native hardware interface or the computing device 150. Generally, when the central controller 200 sends the power on command, it is sent to all the smart hydroponic system modules 100. However, especially when a large structure has compartmentalized areas, it may be desirable to only power on specified areas. This allows an operation to power on the areas in series, and have less than all the light fixtures 122 on at any one time, keeping the current draw low.

After the initial power on, the hydroponic smart system module 100 may be controlled locally, or, said another way, in a closed loop manner. Based on measurements taken by the temperature sensor 118 or sensor package 120, the computing unit 111 may send commands to the lighting fixture 122, the tank valve 102, or the additive valve 108. The computing unit 111 may use a protocol which is standardized and open. Standardized means that it can be used by any device built which may be added to the system 202, either at present or in the future. The protocol may include a list of set commands and messages which may be exchanged between the computing device 150 and the central controller 200, or the computing device 150 and the computing unit 111, or both. Open means that the protocol is designed in such a way that all components may make use of the common portion of the protocol. The conversion may be at the computing device 150, and this portion of the protocol is maintained by a protocol owner. The protocol may include conversion software for any operating systems commonly used on mobile devices and desktop computers. On the opposite side of the protocol, a manufacturer of a component has the freedom to design how the protocol commands are executed. Thus, the manufacturer of a component may take a simple, straightforward approach to hardware design which is capable of receiving the command and executing it.

The temperature sensor 118 may send data to the computing unit 111. The data may include temperature measurements. A user may input parameters in to the computing unit 111 for the temperature sensors 118, either by using the native hardware interface of the central controller 200 or the computing device 150. The central controller 200 or the computing device 150, through the central controller 200, may send the temperature parameters for the computing unit's 111 native dimming and shut down commands. The dimming and shut down commands may be stored as instructions on the memory 124 and executed on the processor 116, with the commands being formed and sent to the lighting fixture 122 according to the protocol.

The dimming command specifies dimming the light fixture 122 to a lower wattage when a temperature measurement exceeds a set parameter. By way of example and not limitation, the computing unit 111 may send a command to dim the light to 50% of the current wattage if a temperature above 80 degrees Fahrenheit is detected by the temperature sensor 118. The temperature may be a parameter set by a user. The parameter may be input using the native hardware interface on the central controller 200 or the user interface on the computing device 150. The amount of dimming desired may be input using the native hardware interface on the central controller 200 or the user interface on the computing device 150, as well.

The shut-down command turns off the light fixture 122 if the temperature sensor 118 detects a temperature indicated in the parameter. By way of example and not limitation, if the temperature sensor detects a temperature of above 90 degrees Fahrenheit, the computing unit 111 commands the lighting fixture 122 to shut down. The temperature parameter may be input using the native hardware interface on the central controller 200 or the user interface on the computing device 150.

Alternatively, or in addition, a liquid temperature sensor on the sensor package 120 may be used in place of, or in conjunction with, the temperature sensor 118. For example, there may be instructions which specify that the light fixture 122 may be sent a dimming command or a shut-down command based on either a temperature parameter set that specifies the command be sent based on a temperature reading matching a first parameter from the temperature sensor 118 as discussed above, or based on a temperature reading matching a second parameter sent from the liquid temperature sensor in the sensor package 120. Or, the dimming or shut down command may be triggered by exceeding a combined parameter set. That is, the dimming or shut down command may only be sent if measurements are outside of two parameters sets, one of which may be based on a measurement from the temperature sensor 118, and the other based on measurements from the sensor package 120. In some embodiments, if only one measurement is outside of the parameters set, the command may not be sent.

The sensor package 120 may take measurements at intervals during the entirety of the cycle, without regard to the light fixture 122 being on or off. Some of the measurements may not be tied to parameters that would trigger commands, while other measurements may be tied to parameters that would trigger commands. For example, the sensor package 120 may include a liquid level sensor. The tank 102 may have known dimensions, thus depending on the liquid level in the tank 102, the volume of liquid in the tank 102 may be calculated. Thus, the liquid level sensor measurement may not be keyed to any parameters, and accordingly, may not trigger any commands. However, the measurements taken by the liquid level sensor may be used in calculations, which are used to determine the scope of commands, or to determine aspects of commands sent to, specifically, the tank valve 104 and the additive valve 108. For example, with a known volume of liquid in a tank 102, and a known flow rate for a valve 104, 108, a time to add a certain volume of liquid may be calculated.

Both while the light fixture 122 is on and off, the computing unit 111 may send commands to the tank valve 104, or the additive valve 108, or both. The commands may be triggered by the sensor package 120 taking measurements that are outside of parameters stored by a user in the memory 124. The sensor package 120 may include a sensor which measures the pH of the liquid. The sensor package 120 may further include a sensor which measures the EC of the liquid. The liquid used may be water, but the smart hydroponics system 100 is not limited to water as the liquid used in the tank 102.

As indicated above, the pH sensor on the sensor package 120 may take measurements at intervals determined by the user throughout the cycle. The pH of the liquid indicates whether it is alkaline, acidic or neutral. If the pH is greater than 7, it is alkaline; if the pH is less than 7, it is acidic. A pH of 7 indicates that the solution is neutral. The plants ability in a hydroponic system to absorb nutrient solution depends on the pH of the nutrient solution. When the nutrient solution is above or below the target pH level, the plant may not receive enough nutrients. Different nutrients are available at different pH ranges. In hydroponics, the ideal pH range may be between 5.8 and 6.2, compared to a pH of 6.5 for soil gardens. Thus, a user may input the parameters of 5.8 and 6.2 in to the memory for the allowable range of pH for the liquid in the tank 102. Depending on various factors, a pH for the liquid outside of 5.8 and 6.2 may be desirable. As these are user selected parameters, they may be changed using the central controller 200 or the computing device 150 to send a message containing the updated parameters to the smart hydroponic system module 100.

When the sensor package 120 sends a measurement above 6.2 for pH to the computing unit 111, the computing unit 111 may use the liquid level measurement for the same time interval to calculate a water volume in the tank 102. Based on the water volume, and a known flow rate from the pH down additive compartment 112 through the additive valve 108 and tank valve 104 and in to the tank 102, calculate a time the additive valve 108 and the tank valve 104 can beneficially be open to add the required amount of pH down solution. The computing unit 111 may send a command to the additive valve 108 and the tank valve 104 to provide fluid communication from the inlets corresponding to the pH down additive tank 112 to the tank 102.

After the calculated time passes, the computing unit 111 may then send a command moving the additive valve 108 and the tank valve 104 to the off position. The calculated time is determined by a calculation made by the processor 116 based on instructions stored in the memory 124. The calculation is made by taking the pH measurement, the volume of liquid in the tank 102, the amount of change a unit of pH down additive will make to a corresponding unit of liquid in the tank, and the flow rate of pH down additive from the pH down additive tank 112 to the tank 102. The calculation results in the amount of time the additive valve 108 and the tank valve 104 should be held open to allow pH down additive to flow in to the tank 102. The calculation should allow the proper amount of pH down additive to flow in to the tank 102 to cause the liquid in the tank 102 to move downward to a pH of 6.0.

Alternatively, the sensor package 120 may send a measurement below 5.8 for the liquid in the tank 102. This is a less common result, especially when water is used as the liquid, but the computing unit 111 recognizes that there is a measurement outside of the user selected parameters for pH, and performs the calculation for the pH up additive. Similar to the pH down additive, the pH up additive flows from the pH tank 130, and specifically the pH up additive compartment 110, through the additive valve 108 and tank valve 104 before entering the tank 102. The computing unit 111 uses the flow rate for the pH up additive in the calculation, as it may differ from the flow rate for the pH down additive. For example, the pH down additive may have a different density or viscosity than the pH up additive. Similar to the process for the pH down additive scenario, the computing unit 111 may send a command that opens the additive valve 108 and tank valve 104 to establish a fluid communication between the pH additive tank 130 and the tank 102. After the calculated time has elapsed, the computing unit 111 then sends a second command to close the additive valve 108 and the tank valve 104. Again, the added pH up additive should bring the pH of the liquid in the tank 102 to 6.0, or the center of the parameter range if an alternate pH range has been input by the user.

Similar to the measurements for pH, the sensor package 102 may also measure the EC of the liquid in the tank 102 at specified intervals. Each of the smart hydroponic system modules 100a-h may contain different varieties of plants, and different plants require different nutrient solution concentrations for growth. It is beneficial to control nutrient solution concentrations in order to provide the improved conditions in the liquid. This allows the improved uptake of nutrients into the rest of the plant's cellular structure. Nutrient solution concentration can be monitored and controlled using electrical conductivity measurements. Electrical conductivity is measure of the ionic strength of a solution and can be converted into concentration. The concentration may be measured in parts per million (PPM). The ability to provide localized control of the smart hydroponic system module 100 means that different varieties of plants may be grown under a single roof, as the EC may be customized to the plants being grown in any particular tank 102.

When the EC sensor in the sensor package 120 measures an EC which is too high for the stored parameters, the computing unit 111 may perform a calculation. The calculation may first determine the volume of water in the tank 102 using the water level measurement from the same time period as the too high EC measurement. The computing unit 111 may then calculate how much liquid should be added to the tank to bring the EC down to a center of the user specified parameters. The calculation may be based on the known flow rate through the tank valve 104 from the liquid source 106. From this, a time may be determined to leave the tank valve 104 open to provide the proper amount of liquid from the liquid source 106. By adding liquid 106, the PPM of the EC will move lower, because those PPM are now placed in a greater volume of liquid. In order to accomplish the adding of the liquid, the computing unit 111 may then send a command to the tank valve 104 to open to provide fluid communication between the liquid source 106 and the tank 102. Liquid will flow from the liquid source 106 through the tank valve 104 and in to the tank 102. After the specified time interval, the computing unit 111 may send another command to the tank valve 104 moving the tank valve 104 to the off position. When the tank valve is in the off position, flow through the tank valve 104 is blocked.

When the EC sensor in the sensor package 120 measure an EC which is too low, the computing unit 111 may perform a calculation. The calculation may first determine the volume of water in the tank 102 using the water level measurement from the same time period as the too high EC measurement. The computing unit 111 may then calculate how much fertilizer should be added to bring the measured EC up to the center of the parameters set by the user. For example, if a user sets EC parameters of 2.0 on the high end, and 1.0 on the low end, the calculation will determine the amount of fertilizer to bring the liquid to an EC of 1.5. Similar to the pH parameters discussed above, the parameters for EC may be set by a user, and may be chosen based on a number of factors. Regardless of exactly where the parameters are set, the computing unit 111 will calculate adjustments to a center of the parameters. Again, the calculation is based on a flow rate of the fertilizer from the fertilizer tank 114, through the additive valve 108 and tank valve 104 and in to the tank 102. Based on the measurements and known data, the computing unit 111 can determine a time period. The computing unit 111 then sends a command opening the additive valve 108 and tank valve 104 to establish fluid communication between the fertilizer tank 114 and the tank 102. After the calculated time, the computing unit 111 sends another command moving the additive valve 108 and the tank valve 104 to the off position, closing fluid communication between the additive valve 108 and the tank 102. The fertilizer used may be a liquid fertilizer.

Alternatively to the additive valve 108 and tank valve 104 configuration, the smart hydroponic module 100 may use a manifold configuration, with the pH up compartment, pH down compartment, the fertilizer, and the liquid source each having a separate valve which is electrically connected to the computing unit 111. The manifold has an outlet which is in fluid communication with the tank 102.

The measurements and adjustments, if required, described above continue throughout the time the light fixtures 122 are on. At the end of the time period for the light fixtures 122 to be on, if automated, the central controller 200 may send a command to all of the connected smart hydroponic system modules 100a-h which have a light fixture 122 turned on. The command may include information for shutting the light fixtures 122 off. The command may include information that ramps the lights down to a complete shut-down, in a reversal of the ramping up when they lights were turned on. The command may specify time intervals for ramping down, and the wattage reduction to be made with each time interval. The central controller 200 may alternatively send a series of commands with each wattage reduction at the specified time intervals. Thus, there are two alternatives, a single command from the central controller 200 with all of the data, and decentralized execution by the computing units 111 of the various smart hydroponic system modules 100a-h, or control retained by the central controller 200 as the central controller 200 sends out wattage reduction commands with no further data at specified time intervals to the smart hydroponic system modules 100a-h. Either way, the central controller 200 may cause the smart hydroponic system modules 100a-h to ramp their light fixture 122 wattage down to simulate a sunset, and then to finally shut down. Again, both the time intervals and the wattage settings may be user selected parameters added to the central controller 200 by the user.

After the central controller 200 or computing units 111 complete the ramp down and the light fixtures 122 are shut down, the remaining components of the smart hydroponic system module 100 continue to function. As discussed above, both the temperature sensor 118 and the sensor package 120 may continue to take measurements and pass the measurements as data to the computing unit 111. In the unlikely event that the temperature sensor 118 or the temperature sensor in the sensor package 120, should a temperature sensor be included with the sensor package 120, provide a measurement that would trigger a command to dim or shut off, nothing happens because the light fixture 122 is already shut off. The fact that the light fixture 122 is shut off in no way affects the operation of the other sensors in the sensor package 120, and potential resulting commands, as described above.

Because all the measurements of the sensor package 120 and potential resulting commands from the computing unit 111 are localized, most functions of the smart hydroponic system module 100 will continue even if the central controller 200 should fail. This is due to the above described open loop/closed loop hybrid architecture of the smart hydroponic system module 100 and the central controller 200. The open loop/closed loop hybrid architecture places the tasks in the hands of the components that can beneficially accomplish them. Because the Sun rises on an entire farm at approximately the same time outdoors, it makes sense to have a central controller 200 turn on all the light fixtures 122 at the same time. However, as discussed above, even indoor environments may vary in temperature, humidity, and other factors that may affect hydroponic systems. Thus, the remaining measurements and adjustments may be left to the local control of the computing unit 111 of the hydroponic smart system 100. Moreover, such measurements and adjustments are automated, as described above. The automation of such tasks greatly reduces the labor required to operate a hydroponic operation, and the localized control of the smart hydroponic system module 100 ensures that the system will provide optimum conditions down to the single light fixture and tank level. This localization, will in turn, guarantee the largest possible crop yields at the lowest labor levels.

Below are some example embodiments described above.

In a 1st Example, a system for hybrid centralized and local control of a hydroponic system, comprising: a central controller which sends commands using a power line control protocol; a computing unit electrically connected to the central controller, the computing unit including a processor and a memory, the memory including instructions executing on the processor to receive measurements, check the measurements against user input parameters, and send commands if the measurements are outside of the input parameters; a light fixture electrically connected to the computing unit; a temperature sensor electrically connected to the computing unit; a tank containing a volume of a liquid; a tank valve in electrical communication with the computing unit, the tank valve including an outlet in fluid communication with the tank, a first tank valve inlet in fluid communication with a liquid source and the outlet, and a second tank valve inlet in fluid communication with the outlet; an additive valve in electrical communication with the computing unit, the additive valve including an outlet in fluid communication with the second tank valve inlet, a first additive valve inlet in fluid communication with a pH tank, and a second additive valve inlet in fluid communication with a fertilizer tank; and a sensor package at least partially submerged in the volume of liquid in the tank, the sensor package including at least a first sensor measuring a pH of the liquid in the tank, a second sensor measuring an electrical conductivity of the liquid in the tank, and a third sensor measuring a liquid level in the tank; wherein, the central controller sends commands to control at least the light fixture, and, based on measurements from the temperature sensor, the sensor package, or both, and wherein the computing unit sends commands to operate the tank valve, the additive valve, and the light fixture.

In a 2nd Example, the system of Example 1, wherein the liquid in the tank is water.

In a 3rd Example, the system of any of Examples 1-2, wherein the commands sent by the central controller are based on user input parameters.

In a 4th Example, the system of any of Example 1-3, wherein the sensor package further includes a second temperature sensor.

In a 5th Example, the system of Example 4, wherein the instructions stored on the memory and executing on the processor checks both the measurement of the temperature sensor and the second temperature sensor against user input parameters before sending commands.

In a 6th Example, the system of Example 5, wherein both the measurements must be outside the user input parameters before sending commands.

In a 7th Example, the system of any of Example 1-6, wherein the tank valve and the additive valve are electrically actuatable between fluid communication between the first inlet and the outlet, fluid communication between the second inlet and the outlet, and an off position with no fluid communication.

In an 8th Example, a method for operating a smart hydroponic system, comprising: providing a central controller connected to a power line; connecting a computing unit to the power line; connecting an air temperature sensor, and at least one sensor submerged in a volume of liquid to the computing unit; placing at least one electrically actuated valve in electrical communication with the computing unit; placing a light fixture in electrical communication with the central controller and the computing unit; sending commands from the central controller using a power line communication protocol, the commands affecting at least operation of the light fixture; and sending commands, based on measurements from the air temperature sensor, or the at least one sensor, from the computing unit to control operation of the of the at least one electrically actuated valve and the light fixture, either separately, or contemporaneously.

In a 9th Example, the method of Example 8, wherein there are two electrically actuated valves in electrical communication with the computing unit.

In a 10th Example, the method of any of Examples 8-9, wherein when sending the commands, the computing unit checks the measurements against user input parameters, and only sends commands if the measurements are outside the user input parameters.

In a 11th Example, the method of any of Examples 8-10, wherein the central controller sends commands using a power line control protocol.

In a 12th Example, the method of any of Examples 8-11, wherein the liquid is water.

In a 13th Example, a system for optimizing hydroponic growth through a combination of central and local control, comprising: a central controller which generates commands using user input parameters; and one or more smart hydroponic system modules electrically connected to the central controller, the one or more smart hydroponic system modules including: a computing unit including a processor and a memory, the memory including a set of instructions which direct the computing unit to receive measurements, and, based on the measurements, process commands for execution on the processor; a temperature sensor electrically connected to the computing unit, the temperature sensor taking a first portion of the measurements and sending the first portion of the measurements to the computing unit; a sensor package electrically connected to the computing unit, the sensor package taking a second portion of the measurements and sending the second portion of the measurements to the computing unit; at least one valve electrically actuatable between establishing fluid communication between a first inlet and an outlet, a second inlet and the outlet, and an off position, the electric actuation being controlled by commands send by the computing unit; and a light fixture electrically connected to the computing unit and the central controller, the light fixture adapted to turn on, turn off, or dim, based on both commands sent from the central controller, and commands sent from the computing unit, the commands from the computing unit being based on either the first portion of the measurements or the second portion of the measurements.

In a 14th Example, the system of Example 13, wherein the central controller sends commands using a power line control protocol.

In a 15th Example, the system of any of Examples 13-14, wherein the computing unit checks the measurements against user input parameters, and, if the measurements are outside the input parameters, processes the commands.

In a 16th Example, the system of any of Examples 13-15, further comprising a first valve and a second valve.

In a 17th Example, the system of Example 16, wherein an outlet of the first valve is connected to a first inlet of the second valve, and the second inlet of the second valve is connected to a liquid source.

In a 18th Example, the system of Example 17, wherein a first inlet of the first valve is connected to a pH tank, and a second inlet of the first valve is connected to a fertilizer tank.

In a 19th Example, the system of any of Example 13-18, wherein the sensor package includes a pH sensor, an electrical conductivity sensor, and a water level sensor.

In a 20th Example, the system of any of Example 13-19, wherein the sensor package is located at least partially submerged in a liquid in a tank.

The above description is given by way of example, and not limitation. Given the above disclosure, one skilled in the art could devise variations that are within the scope and spirit of the invention disclosed herein, including various ways of plumbing the smart hydroponic system modules. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A system for hybrid centralized and local control of a hydroponic system, comprising:
a central controller which sends commands using a power line control protocol;
a computing unit electrically connected to the central controller, the computing unit including a processor and a memory, the memory including instructions executing on the processor to receive measurements, check the measurements against user input parameters, and send commands if the measurements are outside of the input parameters;
a light fixture electrically connected to the computing unit;
a temperature sensor electrically connected to the computing unit;
a tank containing a volume of a liquid;
a tank valve in electrical communication with the computing unit, the tank valve including an outlet in fluid communication with the tank, a first tank valve inlet in fluid communication with a liquid source and the outlet, and a second tank valve inlet in fluid communication with the outlet;
an additive valve in electrical communication with the computing unit, the additive valve including an outlet in fluid communication with the second tank valve inlet, a first additive valve inlet in fluid communication with a pH tank, and a second additive valve inlet in fluid communication with a fertilizer tank; and
a sensor package at least partially submerged in the volume of liquid in the tank, the sensor package including at least a first sensor measuring a pH of the liquid in the tank, a second sensor measuring an electrical conductivity of the liquid in the tank, and a third sensor measuring a liquid level in the tank;
wherein, the central controller sends commands to control at least the light fixture, and, based on measurements from the temperature sensor, the sensor package, or both, and wherein the computing unit sends commands to operate the tank valve, the additive valve, and the light fixture.

2. The system of claim 1, wherein the liquid in the tank is water.

3. The system of claim 1, wherein the commands sent by the central controller are based on user input parameters.

4. The system of claim 1, wherein the sensor package further includes a second temperature sensor.

5. The system of claim 4, wherein the instructions stored on the memory and executing on the processor checks both the measurement of the temperature sensor and the second temperature sensor against user input parameters before sending commands.

6. The system of claim 5, wherein both the measurements must be outside the user input parameters before sending commands.

7. The system of claim 1, wherein the tank valve and the additive valve are electrically actuatable between fluid communication between the first inlet and the outlet, fluid communication between the second inlet and the outlet, and an off position with no fluid communication.

8. A method for operating a smart hydroponic system, comprising:
providing a central controller connected to a power line;
connecting a computing unit to the power line;
connecting an air temperature sensor, and at least one sensor submerged in a volume of liquid to the computing unit;
placing at least one electrically actuated valve in electrical communication with the computing unit;
placing a light fixture in electrical communication with the central controller and the computing unit;
sending commands from the central controller using a power line communication protocol, the commands affecting at least operation of the light fixture; and
sending commands, based on measurements from the air temperature sensor, or the at least one sensor, from the computing unit to control operation of the of the at least one electrically actuated valve and the light fixture, either separately, or contemporaneously.

9. The method of claim 8, wherein there are two electrically actuated valves in electrical communication with the computing unit.

10. The method of claim 8, wherein when sending the commands, the computing unit checks the measurements against user input parameters, and only sends commands if the measurements are outside the user input parameters.

11. The method of claim 8, wherein the central controller sends commands using a power line control protocol.

12. The method of claim 8, wherein the liquid is water.

13. A system for optimizing hydroponic growth through a combination of central and local control, comprising:
a central controller which generates commands using user input parameters; and
one or more smart hydroponic system modules electrically connected to the central controller, the one or more smart hydroponic system modules including:
a computing unit including a processor and a memory, the memory including a set of instructions which direct the computing unit to receive measurements, and, based on the measurements, process commands for execution on the processor;
a temperature sensor electrically connected to the computing unit, the temperature sensor taking a first portion of the measurements and sending the first portion of the measurements to the computing unit;
a sensor package electrically connected to the computing unit, the sensor package taking a second portion of the measurements and sending the second portion of the measurements to the computing unit;
at least one valve electrically actuatable between establishing fluid communication between a first inlet and an outlet, a second inlet and the outlet, and an off position, the electric actuation being controlled by commands send by the computing unit; and
a light fixture electrically connected to the computing unit and the central controller, the light fixture adapted to turn on, turn off, or dim, based on both commands sent from the central controller, and commands sent from the computing unit, the commands from the computing unit being based on either the first portion of the measurements or the second portion of the measurements.

14. The system of claim 13, wherein the central controller sends commands using a power line control protocol.

15. The system of claim 13, wherein the computing unit checks the measurements against user input parameters, and, if the measurements are outside the input parameters, processes the commands.

16. The system of claim 13, further comprising a first valve and a second valve.

17. The system of claim 16, wherein an outlet of the first valve is connected to a first inlet of the second valve, and the second inlet of the second valve is connected to a liquid source.

18. The system of claim 17, wherein a first inlet of the first valve is connected to a pH tank, and a second inlet of the first valve is connected to a fertilizer tank.

19. The system of claim 13, wherein the sensor package includes a pH sensor, an electrical conductivity sensor, and a water level sensor.

20. The system of claim 13, wherein the sensor package is located at least partially submerged in a liquid in a tank.
